(19) United States
(12) Patent Application Publication
(10) Pub. No.: US 2026/0010275 A1
(43) Pub. Date: Jan. 8, 2026

(54) INFORMATION PROCESSING SYSTEM, INFORMATION PROCESSING METHOD, AND NON-TRANSITORY COMPUTER-READABLE MEDIUM STORING PROGRAM CODE

(71) Applicant: Rakuten Group, Inc., Tokyo (JP)

(72) Inventor: Tuba ALI, Tokyo (JP)

(73) Assignee: Rakuten Group, Inc., Tokyo (JP)

(21) Appl. No.: 19/254,129

(22) Filed: Jun. 30, 2025

(30) Foreign Application Priority Data
Jul. 5, 2024 (JP) 2024-108819

(51) Int. Cl. G06F 3/04817

(52) U.S. Cl. CPC G06F 3/04817

(57) ABSTRACT

An information processing system includes one or more memories configured to store program code and one or more processors. The program code includes history acquisition code configured to cause at least one of the one or more processors to acquire at least one of first and second history data respectively indicating operation histories of first and second apps and format code configured to cause at least one of the one or more processors to generate first and second format data respectively indicating display formats of a group of icons in first and second display screens based on at least one of the first and second history data. Display data displaying the group of icons includes first and second display data used to respectively display the group of icons on the first and second display screens in the display formats that are based on the first and second format data.

### CROSS-REFERENCE TO RELATED APPLICATIONS

This application is based upon and claims the benefit of priority from Japanese Patent Application No. 2024-108819, filed on Jul. 5, 2024, the entire contents of which are incorporated herein by reference.

### BACKGROUND

### 1. Field

The present disclosure relates to an information processing system, an information processing method, and a non-transitory computer-readable medium storing program code.

### 2. Description of Related Art

In recent years, applications (hereinafter referred to as apps) configured to provide multiple services to users have been made available. Japanese Laid-Open Patent Publication No. 2022-148875 discloses a first app and a second app in which multiple icons, each associated with a respective service, are displayed. A user operates an icon to use a service associated with that icon.

Among the services provided by each app, some are used by users more frequently than others. Accordingly, there is a demand to suitably display icons to users in the first and second apps.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

An information processing system according to an aspect of the present disclosure includes one or more memories configured to store program code and one or more processors. The one or more processors are configured to read the program code and operate as instructed by the program code. The program code includes sending code configured to cause at least one of the one or more processors to send, to a user terminal, display data on a display of the user terminal. The display data is used to display a group of icons including multiple icons. Some of the icons are included in both a first display screen of a first app and a second display screen of a second app. The program code includes history acquisition code configured to cause at least one of the one or more processors to acquire at least one of first history data and second history data. The first history data indicates an operation history of a group of icons in the first app. The second history data indicates an operation history of a group of icons in the second app. The program code includes format code configured to cause at least one of the one or more processors to generate first format data and second format data based on at least one of the first history data and the second history data. The first format data indicates a display format of the group of icons on the first display screen. The second format data indicates a display format of the group of icons on the second display screen. The display data includes first display data used to display the group of icons on the first display screen in the display format that is based on the first format data and second display data used to display the group of icons on the second display screen in the display format that is based on the second format data.

An information processing method according to an aspect of the present disclosure includes sending, by at least one of one or more processors, to a user terminal, display data on a display of the user terminal. The display data is used to display a group of icons including multiple icons. Some of the icons are included in both a first display screen of a first app and a second display screen of a second app. The information processing method includes acquiring, by at least one of the one or more processors, at least one of first history data and second history data. The first history data indicates an operation history of a group of icons in the first app. The second history data indicates an operation history of a group of icons in the second app. The information processing method includes generating, by at least one of the one or more processors, first format data and second format data based on at least one of the first history data and the second history data. The first format data indicates a display format of the group of icons on the first display screen. The second format data indicates a display format of the group of icons on the second display screen. The display data includes first display data used to display the group of icons on the first display screen in the display format that is based on the first format data and second display data used to display the group of icons on the second display screen in the display format that is based on the second format data.

A non-transitory computer-readable medium according to an aspect of the present disclosure stores program code. The program code includes sending code configured to cause at least one of one or more processors to send, to a user terminal, display data on a display of the user terminal. The display data is used to display a group of icons including multiple icons. Some of the icons are included in both a first display screen of a first app and a second display screen of a second app. The program code includes history acquisition code configured to cause at least one of the one or more processors to acquire at least one of first history data and second history data. The first history data indicates an operation history of a group of icons in the first app. The second history data indicates an operation history of a group of icons in the second app. The program code includes format code configured to cause at least one of the one or more processors to generate first format data and second format data based on at least one of the first history data and the second history data. The first format data indicates a display format of the group of icons on the first display screen. The second format data indicates a display format of the group of icons on the second display screen. The display data includes first display data used to display the group of icons on the first display screen in the display format that is based on the first format data and second display data used to display the group of icons on the second display screen in the display format that is based on the second format data.

Other features and aspects will be apparent from the following detailed description, the drawings, and the claims.

### BRIEF DESCRIPTION OF THE DRAWINGS

FIG. 1 is a diagram illustrating an example of an information processing system.

FIG. 2 is a block diagram illustrating an example of the user terminal.

FIG. 3 is a diagram illustrating an example of the display screen of the first app.

FIG. 4 is a diagram illustrating an example of the display screen of the second app.

FIG. 5 is a block diagram illustrating an example of the display control server.

FIG. 6 is a table illustrating an example of history data.

FIG. 7 is a table illustrating an example of format data.

FIG. 8 is a table illustrating an example of weight data.

FIG. 9 is a table illustrating an example of result values.

FIG. 10 is a flowchart illustrating an example of information processing.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

An information processing system, an information processing method, and a non-transitory computer-readable medium storing program code according to an embodiment will now be described with reference to the drawings. In this specification, an information processing system 11 including one or more servers will be described as an example.

### Information Processing System

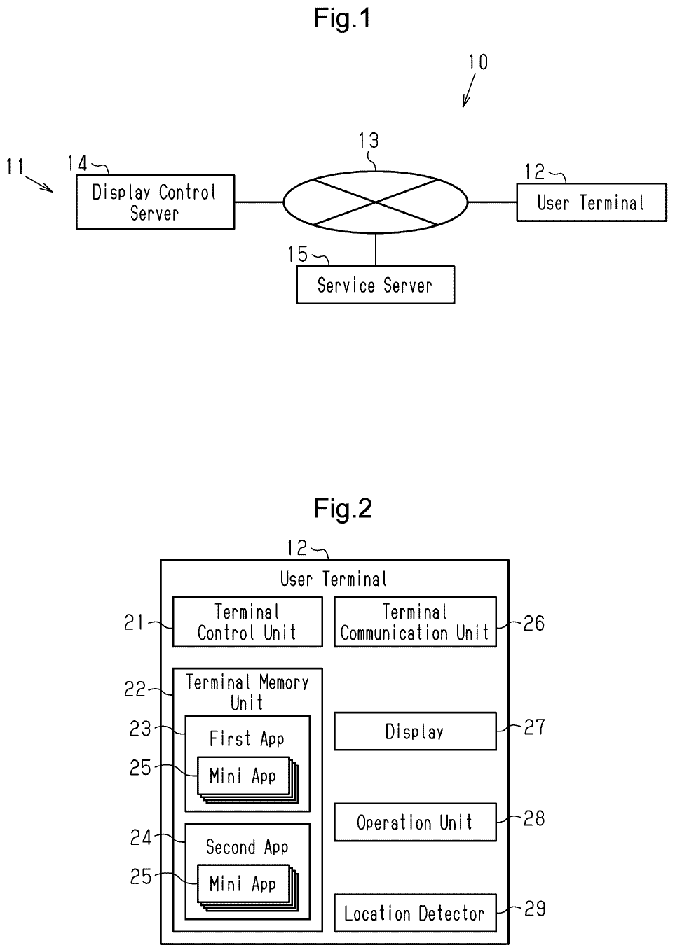

As shown in FIG. 1, the information processing system 11 is configured to communicate with a user terminal 12. The information processing system 11 is configured to process information. The information processing system 11 is configured to control a screen displayed on the user terminal 12. The user terminal 12 is owned by a user. The information processing system 11 and the user terminal 12 are connected to a network 13. The network 13 is a communication network including, for example, a LAN and a WAN. The information processing system 11 and the user terminal 12 communicate with each other via the network 13.

The information processing system 11 includes one or more display control servers 14. The information processing system 11 may include one display control server 14 or may include multiple display control servers 14. The display control servers 14 may communicate with each other via the network 13. Each display control server 14 communicates with the user terminal 12 via the network 13. The display control server 14 is configured to cause the user terminal 12 to display a screen. The information processing system 11 controls a screen displayed on the user terminal 12 by the display control server 14.

The display control server 14 may be configured to provide a service to a user. The display control server 14 may provide the user with services such as an electronic commerce service, an electronic payment service, a reward granting service, a financial service, a travel reservation service, a communication service, a music streaming service, a video streaming service, and a food delivery service. The user uses such a service by operating the user terminal 12.

The information processing system 11 may be configured to provide multiple services to the user from one display control server 14. The information processing system 11 may be configured such that multiple display control servers 14 each provide a different service to the user. The information processing system 11 may be configured such that multiple display control servers 14 cooperate with each other to provide one service from the display control servers 14 to the user. The information processing system 11 may include one display control server 14 configured to provide multiple services, or may include multiple display control servers 14 each configured to provide a different service.

The information processing system 11 may include one or more service servers 15. The service server 15 is connected to the network 13. The service server 15 communicates with the user terminal 12 via the network 13. The service server 15 may communicate with the display control server 14 via the network 13. The service server 15 has the same hardware configuration as the display control server 14.

The service server 15 provides a service to a user. One service server 15 may provide multiple services to the user. Multiple service servers 15 may each provide a different service to the user. Multiple service servers 15 may cooperate with each other to provide one service to the user. The business entity of the service server 15 may be different from that of the display control server 14. The service server 15 may include a server that is not included in the information processing system 11.

### User Terminal

The user terminal 12 will now be described.

As illustrated in FIG. 2, the user terminal 12 includes a control unit and a memory unit. Specifically, the user terminal 12 includes a terminal control unit 21 and a terminal memory unit 22. The terminal control unit 21 includes a processor. The terminal memory unit 22 includes a memory such as a ROM and a RAM. The terminal memory unit 22 is configured to store a program. The terminal control unit 21 is configured to execute processing in accordance with the program stored in the terminal memory unit 22. Thus, the user terminal 12 is implemented as a computer. Examples of the user terminal 12 include a smartphone, a tablet, and a smartwatch. The user terminal 12 may be a personal computer.

The terminal memory unit 22 stores an app including a program. The app may include an app that is preinstalled in the terminal memory unit 22 in advance, or may include a native app, a web app, or the like that is installed in the terminal memory unit 22 from outside by a user's operation. The native app is installed from an app store. The web app runs in a browser. The user uses a service provided via an app by operating the app.

The terminal memory unit 22 stores multiple super apps. A super app is an integrated app that includes multiple services. A super app is also referred to as a parent app. A super app is, for example, a native app.

A super app is configured to provide multiple services to a user. A super app allows a user to use multiple services. Accordingly, compared to a case in which multiple apps each providing a respective service are launched, usability is improved.

The terminal memory unit 22 stores two super apps. Specifically, the terminal memory unit 22 stores a first app 23 and a second app 24. The terminal memory unit 22 may store three or more super apps. Examples of the first app 23 and the second app 24 include a shopping app, a digital wallet app, and a check-in app. For example, the first app 23 is a shopping app. For example, the second app 24 is a digital wallet app. The shopping app provides an electronic commerce service. The user purchases a product through the shopping app. The digital wallet app provides an electronic payment service. The user pays a fee through the digital wallet app. The check-in app provides a reward granting service.

Specifically, the check-in app provides a service that gives rewards to a user who has visited pre-registered spots such as stores or facilities. The check-in app determines whether the user has visited a registered spot based on the location information of the user terminal 12. The user acquires a reward (e.g., a coupon or points) through the check-in app. Points are tokens that are applicable at the time of, for example, product purchase or service use.

Each of the first app 23 and the second app 24 includes multiple mini apps 25. The first app 23 and the second app 24 each provide multiple services to the user through the mini apps 25.

Each mini app 25 runs on a super app as its platform. The mini app 25 is also referred to as a child app. The mini app 25 is developed to run in the super app. The mini app 25 is developed based on a software development kit (SDK) provided by the developer of a super app. The SDK includes, for example, programs and technical documents that are used for app development. The mini app 25 becomes installable on a super app when it is developed based on the SDK. The mini app 25 is associated with the super app. As the super app is installed on the user terminal 12, the mini app 25 is installed on the user terminal 12 together with the super app. The mini app 25 may be selectively installed through the super app by the user operating the super app. The mini app 25 may be implemented in a web view. For example, the mini app 25 may display web content described in HTML. In the first app 23, the user can launch a mini app 25 included in the first app 23. In the second app 24, the user can launch a mini app 25 included in the second app 24. Multiple mini apps 25 included in the first app 23 and multiple mini apps 25 included in the second app 24 may be the same as or different from each other.

Each mini app 25 is configured to provide a service to a user. Examples of the mini app 25 include a point investment app, a cash advance app, a travel app, a mobile app, a music app, a news app, a rock-paper-scissors app, a banking app, a food delivery app, and a browser app. The point investment app provides a reward granting service. The cash advance app provides a financial service. The travel app provides a travel reservation service. The mobile app provides a communication service. The music app provides a music streaming service. The news app provides a news notification service. The rock-paper-scissors app provides a reward granting service. The banking app provides a financial service. The food delivery app provides a food delivery service. The browser app provides a webpage browsing service. For example, the first app 23 allows the user to launch the news app or the rock-paper-scissors app. For example, the second app 24 allows the user to launch the point investment app or the cash advance app.

The user terminal 12 includes a terminal communication unit 26. The terminal communication unit 26 may include a wired communication interface or a wireless communication interface. The user terminal 12 is connected to the network 13 by the terminal communication unit 26. The user terminal 12 sends and receives data through the terminal communication unit 26.

The user terminal 12 includes a display 27. Examples of the display 27 include a liquid crystal display and an organic EL display. When the user launches an app, a screen related to the app is displayed on the display 27.

The user terminal 12 includes an operation unit 28. The operation unit 28 is, for example, a touch panel. The operation unit 28 may also be, for example, a pointing device or a keyboard. The user launches or operates an app through the operation unit 28.

The user terminal 12 may include a location detector 29. The location detector 29 is configured to detect the location of the user terminal 12. The location detector 29 includes a sensor that receives a signal transmitted from the outside. The location detector 29 may be configured to receive, for example, a signal transmitted from a satellite or a signal transmitted from a beacon. The location detector 29 detects the location of the user terminal 12 based on the received signal. The user terminal 12 acquires location information using the location detector 29.

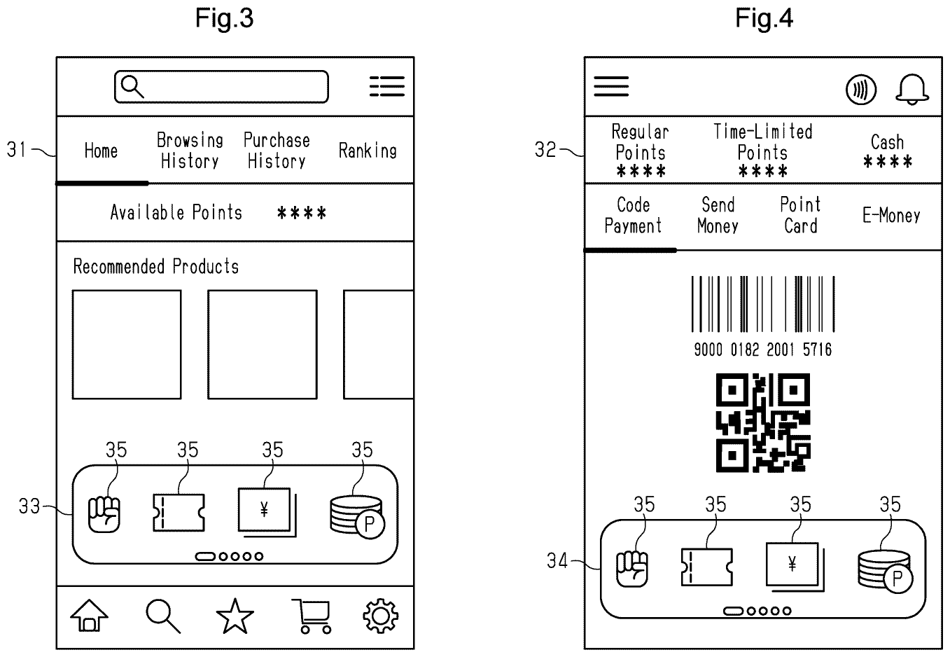

As shown in FIG. 3, upon launch of the first app 23, a screen related to the first app 23 is displayed. For example, upon launch of the first app 23, the home screen 31 is displayed. The first app 23 is configured to display the home screen 31. The home screen 31 displays a product that can be purchased. The home screen 31 may display points available to the user.

The first app 23 may be configured to display, for example, a browsing history screen, a purchase history screen, or a ranking screen in addition to the home screen 31. The browsing history screen displays a list of products that has been browsed by the user in the electronic commerce service provided by the first app 23. The purchase history screen displays a list of products that have been purchased by the user in the electronic commerce service provided by the first app 23. The ranking screen displays a list of best-selling products in the electronic commerce service provided by the first app 23.

As illustrated in FIG. 4, upon launch of the second app 24, a screen related to the second app 24 is displayed. For example, upon launch of the second app 24, a code screen 32 is displayed. The second app 24 is configured to display the code screen 32. The code screen 32 displays a payment code. Examples of the payment code include a barcode, a character code, and a two-dimensional code. The code screen 32 may display points held by the user.

The second app 24 may be configured to display, for example, a money transfer screen, a point card screen, or an electronic money screen in addition to the code screen 32. The money transfer screen allows a user to send electronic money to another user. The point card screen displays a point card. The electronic money screen displays information related to electronic money. The electronic money screen allows a user to perform operations such as checking the balance of electronic money and adding value to it.

As shown in FIGS. 3 and 4, the first app 23 and the second app 24 are each configured to display a display screen based on display data. Specifically, the first app 23 is configured to display a first display screen 33 based on first display data, which is included in the display data. The second app 24 is configured to display a second display screen 34 based on second display data, which is included in the display data.

Each display screen displays a group of icons including multiple icons 35 based on the display data. Each icon 35 is associated with an app. The icon 35 is a symbol indicating the associated app using a character, a figure, or a combination thereof. The first app 23 and the second app 24 are each configured to launch the app associated with an icon 35 when the icon 35 is selected.

Multiple icons 35 include one or more icons 35 associated with a mini app 25. That is, multiple icons 35 each include a mini app icon associated with a mini app 25. The first app 23 and the second app 24 are each configured to launch the mini app 25 corresponding to a mini app icon when the mini app icon is selected. For example, when the icon 35 corresponding to the rock-paper-scissors app is selected in the first app 23 and the second app 24, the rock-paper-scissors app is launched.

Multiple icons 35 may include one or more icons 35 associated with an app other than a mini app 25. For example, multiple icons 35 may include one or more icons 35 associated with a super app. Multiple icons 35 displayed on the first display screen 33 may include an icon 35 associated with the second app 24. Multiple icons 35 displayed on the second display screen 34 may include an icon 35 associated with the first app 23. When the icon 35 associated with the second app 24 is selected on the first display screen 33, the second app 24 is launched. When the icon 35 associated with the first app 23 is selected on the second display screen 34, the first app 23 is launched. Multiple icons 35 may include one or more icons 35 associated with a native app that is different from each of the first app 23 and the second app 24. Multiple icons 35 may include one or more icons 35 indicating a deep link that redirects the user to another app.

Each display screen may be overlaid on another screen. For example, the first display screen 33 is overlaid on the home screen 31. For example, the second display screen 34 is overlaid on the code screen 32. The first display screen 33 may be overlaid on a screen such as the browsing history screen, the purchase history screen, or the ranking screen. The second display screen 34 may be overlaid on a screen such as the money transfer screen, the point card screen, or the electronic money screen.

Each display screen may occupy only a portion of another screen. For example, the first display screen 33 may occupy only a portion of the home screen 31, the browsing history screen, the purchase history screen, or the ranking screen. For example, the second display screen 34 may occupy only a portion of a screen such as the code screen 32, the money transfer screen, the point card screen, or the electronic money screen.

Each display screen may be displayed as a result of a transition from another screen. For example, the first display screen 33 may be displayed as a result of a transition from another screen such as the home screen 31, the browsing history screen, the purchase history screen, or the ranking screen. For example, the second display screen 34 may be displayed as a result of a transition from another screen such as the code screen 32, the money transfer screen, the point card screen, or the electronic money screen.

Each display screen may include multiple pages. The display screen may display multiple icons 35 by means of multiple pages. The display screen may display one icon 35 per page, or may display multiple icons 35 per page. For example, the display screen displays four icons 35 per page. The display screen may be configured to allow pages to be switched. For example, the display screen indicates the current page with a dot indicator.

The display screen may be configured to be scrollable. The display screen may display multiple icons 35 through scrolling. For example, the display screen may display the icons 35 one after another using a slider. The display screen may display a list of all the icons 35.

The user launches the app associated with an icon 35 by selecting the icon 35 from the display screen. Accordingly, the user is provided with the service associated with the icon 35. Multiple icons 35 include frequently used icons 35 and infrequently used icons 35. That is, the services included in each of the first app 23 and the second app 24 include services that the user uses frequently and services that the user uses infrequently. Accordingly, displaying frequently used icons 35 in a manner that facilitates easier selection enhances usability.

### Display Control Server

The display control server 14 will now be described.

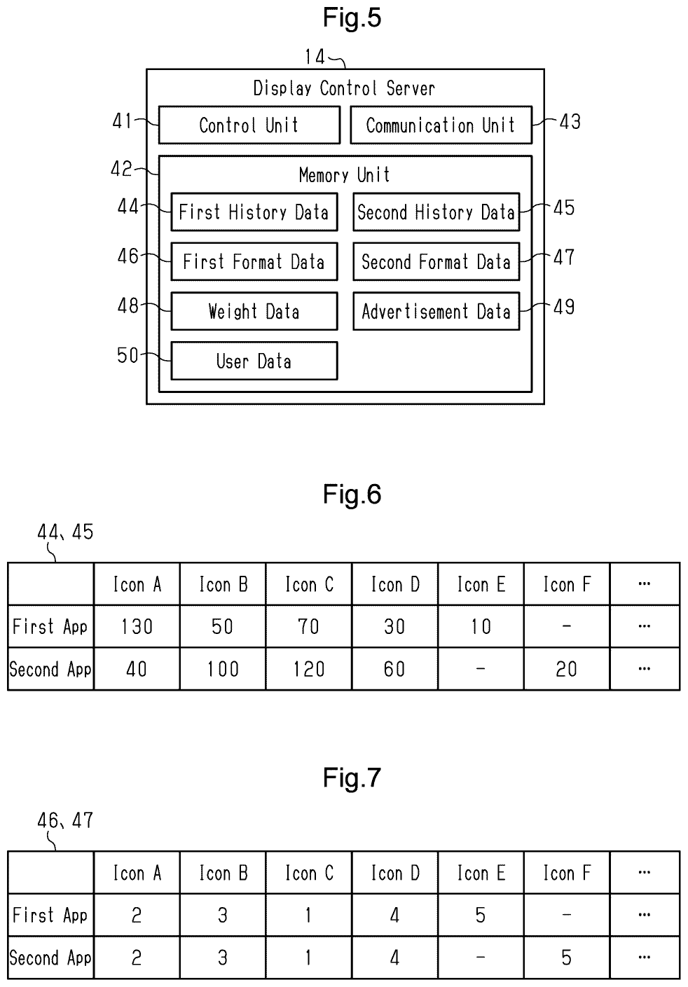

As illustrated in FIG. 5, the display control server 14 includes a control unit 41 and a memory unit 42. The control unit 41 includes a processor. The memory unit 42 includes a memory such as a ROM and a RAM. The memory unit 42 is configured to store a program. The control unit 41 is configured to execute processing in accordance with the program stored in the memory unit 42. Thus, the display control server 14 is implemented as a computer.

The display control server 14 is configured to cause the user terminal 12 to display a display screen. The display control server 14 is configured to cause the first app 23 to display the first display screen 33. The display control server 14 is configured to cause the second app 24 to display the second display screen 34. The display control server 14 that causes the first app 23 to display the first display screen 33 may be the same as or different from the display control server 14 that causes the second app 24 to display the second display screen 34.

The display control server 14 includes a communication unit 43. The communication unit 43 may include a wired communication interface or a wireless communication interface. The display control server 14 is connected to the network 13 by the communication unit 43. The display control server 14 sends and receives data through the communication unit 43.

The display control server 14 is configured to read various types of data. The display control server 14 is configured to read data such as first history data 44, second history data 45, first format data 46, second format data 47, weight data 48, advertisement data 49, and user data 50. The display control server 14 executes processing based on various types of data.

Various types of data may be stored in the display control server 14, the service server 15, or a database that is different from the display control server 14 and the service server 15. Various types of data only need to be stored so as to be readable by the display control server 14.

History data may be stored in the memory unit 42. For example, the first history data 44 and the second history data 45 are stored in the memory unit 42. History data indicates the operation history of a super app. Specifically, history data indicates the operation history of a group of icons.

The first history data 44 indicates the operation history of the first app 23. The first history data 44 indicates the operation history of a group of icons displayed on the first display screen 33. The first history data 44 relates to a first use frequency. The first use frequency relates to the use of an icon 35 in the first app 23. The second history data 45 indicates the operation history of the second app 24. The second history data 45 indicates the operation history of a group of icons displayed on the second display screen 34. The second history data 45 relates to a second use frequency. The second use frequency relates to the use of an icon 35 in the second app 24. The control unit 41 uses history data to identify frequently used services and infrequently used services in the first app 23 and the second app 24.

History data is generated by a server, such as the display control server 14 and the service server 15, communicating with the user terminal 12. For example, the server accumulates parameters from a request signal sent from the user terminal 12, thereby generating history data. When the user operates an app, the user terminal 12 sends a request signal to the server. When the server sends a response signal corresponding to the request signal to the user terminal 12, the app starts running. For example, when the user selects an icon 35 in the first app 23, a request signal is sent from the user terminal 12 to a server that provides a service associated with the icon 35. When the server sends a response signal corresponding to the request signal to the user terminal 12, the app associated with the icon 35 starts running. The same applies to the second app 24.

As illustrated in FIG. 6, the first history data 44 and the second history data 45 each indicate the number of operations performed on an icon 35. The first history data 44 and the second history data 45 may each indicate whether the icon 35 has been operated. With reference to the example illustrated in FIG. 6, the number of operations performed on each of the icons A, B, C, D, E, and F included in multiple icons 35 will be described.

The first history data 44 indicates the number of operations performed on an icon 35 in the first app 23. In the example illustrated in FIG. 6, the first history data 44 indicates that the number of operations performed on icon A is 130, the number of operations performed on icon B is 50, the number of operations performed on icon C is 70, the number of operations performed on icon D is 30, and the number of operations performed on icon E is 10. In this example, the first history data 44 does not store the number of operations performed on icon F. This is because the app associated with icon F is not installed in the first app 23.

The second history data 45 indicates the number of operations performed on an icon 35 in the second app 24. In the example illustrated in FIG. 6, the second history data 45 indicates that the number of operations performed on icon A is 40, the number of operations performed on icon B is 100, the number of operations performed on icon C is 120, the number of operations performed on icon D is 60, and the number of operations performed on icon F is 20. In this example, the second history data 45 does not store the number of operations performed on icon E. This is because the app associated with icon E is not installed in the second app 24.

As shown in FIG. 5, the format data may be stored in the memory unit 42. For example, the first format data 46 and the second format data 47 are stored in the memory unit 42. The format data indicates the display format of a display screen. Specifically, the format data indicates the display format of multiple icons 35 in the super app. The first format data 46 indicates the display format of the first display screen 33. The first format data 46 indicates the display format of multiple icons 35 in the first app 23. The second format data 47 indicates the display format of the second display screen 34. The second format data 47 indicates the display format of multiple icons 35 in the second app 24.

The format data indicates the order of multiple icons 35. The format data may indicate an icon 35 that is to be highlighted. The format data may indicate whether an icon 35 is to be displayed or hidden. The format data may include other data in addition to the data indicating a display format, and may include, for example, image data of an icon 35. The display screen is displayed based on the format data. Based on the format data, the control unit 41 causes the user terminal 12 to display the display screen.

The format data is generated based on history data. The control unit 41 generates the format data based on history data. The control unit 41 generates the first format data 46 and the second format data 47 based on at least one of the first history data 44 and the second history data 45. That is, the control unit 41 generates the first format data 46 and the second format data 47 based on the first history data 44, the second history data 45, or both.

The format data is generated such that the icon 35 associated with a frequently used service is likely to be selected on the display screen. That is, the format data indicates a display format in which the icon 35 associated with a frequently used service is likely to be selected. The display format is determined based on use frequency. The display format is determined based on at least one of the first use frequency and the second use frequency.

The format data is generated such that icons 35 are arranged in descending order of use frequency in a display screen. The format data may be generated such that frequently used icons 35 are highlighted in a display screen. For example, the format data may be generated such that frequently used icons 35 are displayed larger than infrequently used icons 35 in a display screen. The format data may be generated such that infrequently used icons 35 are hidden in a display screen.

As illustrated in FIG. 7, the first format data 46 and the second format data 47 each indicate the order of icons 35. The order of icons 35 is determined by the use frequency of the icons 35. The use frequency may be represented by the number of operations performed on the icons 35. In the example illustrated in FIG. 7, the order of icons A, B, C, D, E, and F of multiple icons 35 will be described.

The first format data 46 indicates the order of the icons 35 in the first app 23. In the example illustrated in FIG. 7, the first format data 46 indicates that icons C, A, B, D, and E are displayed in this order. In this example, the first format data 46 does not store a value indicating the position of icon F. This is because the app associated with icon F is not installed in the first app 23.

The second format data 47 indicates the order of the icons 35 in the second app 24. In the example illustrated in FIG. 7, the second format data 47 indicates that icons C, A, B, D, and F are displayed in this order. In this example, the second format data 47 does not store a value indicating the position of icon E. This is because the app associated with icon E is not installed in the second app 24.

In the example illustrated in FIG. 7, the order of icons 35 is determined based on the sum of the number of operations performed on the first app 23 and the number of operations performed on the second app 24. For example, the sum of the number of operations performed on icon A is 170, and the sum of the number of operations performed on icon B is 150. Accordingly, icon A is arranged at a higher rank than icon B. The order of icons 35 does not have to be determined based on the sum of the number of operations performed on the first app 23 and the number of operations performed on the second app 24. Instead, the order of the icons 35 may be determined based on the number of operations performed on the first app 23, or may be determined based on the number of operations performed on the second app 24.

To determine the order of the icons 35 in the first app 23 and the order of the icons 35 in the second app 24, different history data may be referred to. For example, the order of the icons 35 in the first app 23 may be determined based on the sum of the number of operations performed on the first app 23 and the number of operations performed on the second app 24, while the order of the icons 35 in the second app 24 may be determined based on the number of operations performed on the first app 23 or the number of operations performed on the second app 24. Instead, the order of the icons 35 in the first app 23 may be determined based on the number of operations performed on the first app 23 or the number of operations performed on the second app 24, while the order of the icons 35 in the second app 24 may be determined based on the sum of the number of operations performed on the first app 23 and the number of operations performed on the second app 24.

The first format data 46 and the second format data 47 may be generated such that the first display screen 33 and the second display screen 34 have the same display format (i.e., such that some of the icons 35 are included in both the first display screen 33 and the second display screen 34). When multiple icons 35 displayed on the first display screen 33 are identical to multiple icons 35 displayed on the second display screen 34, the first format data 46 and the second format data 47 are generated in the same manner, so that the first display screen 33 and the second display screen 34 are displayed in the same manner. For example, the order of the icons 35 in both the first app 23 and the second app 24 is determined based on the sum of the number of operations performed on the first app 23 and the number of operations performed on the second app 24, so that the order of the icons 35 in both the first app 23 and the second app 24 matches. Thus, the user experience is unified between the first display screen 33 and the second display screen 34 in the first app 23 and the second app 24.

As shown in FIG. 5, the weight data 48 may be stored in the memory unit 42. The weight data 48 is used to weight operation histories. That is, the weight data 48 is used to correct history data. The weight data 48 indicates one or more weight values. The display format may be determined by an operation history and a weight value. The use frequency may be represented by an operation history and a weight value. The format data may be generated based on the history data and the weight data 48.

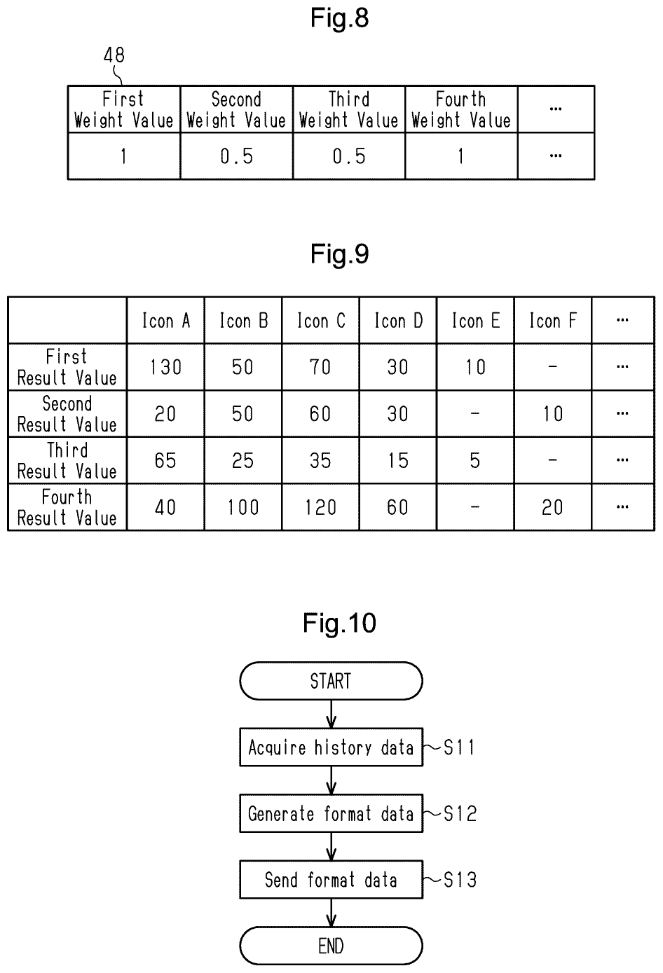

As shown in FIG. 8, the weight data 48 includes multiple weight values. With reference to the example illustrated in FIG. 8, a first weight value, a second weight value, a third weight value, and a fourth weight value will be described. For example, the first weight value is used to weight the first history data 44. The first weight value is used to generate the first format data 46. The second weight value is used to weight the second history data 45. The second weight value is used to generate the first format data 46. The third weight value is used to weight the first history data 44. The third weight value is used to generate the second format data 47. The fourth weight value is used to weight the second history data 45. The fourth weight value is used to generate the second format data 47.

The first weight value is different from the second weight value. For example, the first weight value is greater than the second weight value. In the example illustrated in FIG. 8, the first weight value is 1. The second weight value is 0.5.

The third weight value is different from the fourth weight value. For example, the third weight value is smaller than the fourth weight value. In the example illustrated in FIG. 8, the third weight value is 0.5. The fourth weight value is 1.

Referring to FIG. 9, a result value may be derived by correcting an operation history to a weight value. The result value is derived by the control unit 41. The result value represents a use frequency. The first weight value is used to obtain a first result value. The second weight value is used to obtain a second result value. The third weight value is used to obtain a third result value. The fourth weight value is used to obtain a fourth result value.

The first result value is obtained by correcting, with the first weight value, the operation history indicated by the first history data 44. For example, the first result value is obtained by weighting, with the first weight value, the number of operations indicated by the first history data 44. Specifically, the first result value is obtained by multiplying, by the first weight value, the number of operations indicated by the first history data 44. The first result value of icon A is 130×1=130. The first result value of icon B is 50×1=50. The first result value of icon C is 70×1=70. The first result value of icon D is 30×1=30. The first result value of icon E is 10×1=10.

The second result value is obtained by correcting, with the second weight value, the operation history indicated by the second history data 45. For example, the second result value is obtained by weighting, with the second weight value, the number of operations indicated by the second history data 45. Specifically, the second result value is obtained by multiplying, by the second weight value, the number of operations indicated by the second history data 45. The second result value of icon A is 40×0.5=20. The second result value of icon B is 100×0.5=50. The second result value of icon C is 120×0.5=60. The second result value of icon D is 60×0.5=30. The second result value of icon F is 20×0.5=10.

The third result value is obtained by correcting, with the third weight value, the operation history indicated by the first history data 44. For example, the third result value is obtained by weighting, with the third weight value, the number of operations indicated by the first history data 44. Specifically, the third result value is obtained by multiplying, by the third weight value, the number of operations indicated by the first history data 44. The third result value of icon A is 130×0.5=65. The third result value of icon B is 50×0.5=25. The third result value of icon C is 70×0.5=35. The third result value of icon D is 30×0.5=15. The third result value of icon E is 10×0.5=5.

The fourth result value is obtained by correcting, with the fourth weight value, the operation history indicated by the second history data 45. For example, the fourth result value is obtained by weighting, with the fourth weight value, the number of operations indicated by the second history data 45. Specifically, the fourth result value is obtained by multiplying, by the fourth weight value, the number of operations indicated by the second history data 45. The fourth result value of icon A is 40×1=40. The fourth result value of icon B is 100×1=100. The fourth result value of icon C is 120×1=120. The fourth result value of icon D is 60×1=60. The fourth result value of icon F is 20×1=20.

The first format data 46 may be generated based on the first result value and the second result value. For example, the first format data 46 may be generated based on the sum of the first result value and the second result value. For example, in icon A, the sum of the first result value and the second result value is 130+20=150. In icon B, the sum of the first result value and the second result value is 50+50=100. In icon C, the sum of the first result value and the second result value is 70+60=130. In icon D, the sum of the first result value and the second result value is 30+30=60. In icon E, the sum of the first result value and the second result value is 10. Thus, the first format data 46 is generated such that icons A, C, B, D, and E are displayed in this order based on the first result value and the second result value. In this case, the first display screen 33 has a display format that strongly reflects the operation history of the first app 23.

The second format data 47 may be generated based on the third result value and the fourth result value. For example, the second format data 47 may be generated based on the sum of the third result value and the fourth result value. For example, in icon A, the sum of the third result value and the fourth result value is 65+40=105. In icon B, the sum of the third result value and the fourth result value is 25+100=125. In icon C, the sum of the third result value and the fourth result value is 35+120=155. In icon D, the sum of the third result value and the fourth result value is 15+60=75. In icon F, the sum of the third result value and the fourth result value is 20. Thus, the second format data 47 is generated such that icons C, B, A, D, and F are displayed in this order based on the third result value and the fourth result value. In this case, the second display screen 34 has a display format that strongly reflects the operation history of the second app 24.

The second format data 47 may be generated based on the first result value and the second result value, and the first format data 46 may be generated based on the third result value and the fourth result value. To generate format data, any combination of an operation history and a weight value may be used. To generate format data, any weight value may be used to correct an operation history. For example, each icon 35 may be assigned to a respective weight value. For example, a larger weight value may be set for an icon 35 displayed on only one of the first app 23 and the second app 24 than for an icon 35 displayed on both the first app 23 and the second app 24. An icon 35 displayed on only one of the first app 23 and the second app 24 is likely to be performed a relatively small number of times. Thus, the use frequency is suitably evaluated by setting a relatively large weight value.

Multiple icons 35 are each associated with a respective service. As shown in FIG. 5, the advertisement data 49 may be stored in the memory unit 42. The advertisement data 49 indicates an advertisement fee that is individually set for each of multiple services included in the first app 23 and the second app 24. In other words, an advertisement fee is individually set for each icon 35. The advertisement fee is set under a discussion between the provider of a super app and the provider of a mini app 25.

The advertisement fee is paid from the provider of the mini app 25 to the provider of the super app. For example, the advertisement fee is incurred when an icon 35 is selected. That is, the advertisement fee is incurred in accordance with the number of times the mini app 25 is launched. The advertisement fee does not have to be incurred in accordance with the number of times the mini app 25 is launched, and may be incurred in a predetermined period, for example.

The advertisement data 49 may be used to generate format data. The format data may be generated based on the history data and the advertisement data 49. The format data may be generated based on the history data, the weight data 48, and the advertisement data 49. For example, an icon 35 may be weighted separately from the use frequency based on the advertisement fee indicated by the advertisement data 49. The format data may be generated based on the sum of the use frequency and the advertisement fee. The format data may be generated based on the product of the use frequency and the advertisement fee. In addition to the first result value of icon A and the first result value of icon B, the order of icons A and B on the first display screen 33 may be determined based on the advertisement fee set for icon A and the advertisement fee set for icon B. In this case, the icon 35 with a higher advertisement fee is likely to be displayed above one with a lower advertisement fee.

The user data 50 may be stored in the memory unit 42. The user data 50 relates to a user who uses the user terminal 12. The user data 50 is accumulated by communication between the display control server 14 and the user terminal 12. The user data 50 represents, for example, the age group, household, income, occupation, location, interest, and preference of the user. The user data 50 may include current location information of the user. The location information is transmitted from the user terminal 12 and stored in the memory unit 42.

The user data 50 may be used to generate format data. The format data may be generated based on the history data and the user data 50. The format data may be generated based on the history data, the weight data 48, and the user data 50. The format data may be generated based on the history data, the weight data 48, the advertisement data 49, and the user data 50.

An icon 35 may be weighted separately from the use frequency based on the degree of matching between the user profile indicated by the user data 50 and the service associated with the icon 35. The format data may be generated based on the degree of matching and the use frequency. For example, for a user who is interested in news, the format data may be generated such that the user can readily select the icon 35 associated with a news app. For a user who likes pizza, the format data may be generated such that the user can readily select the icon 35 associated with a pizza delivery app. Based on the location information of the user, the format data may be generated such that the user can readily select the icon 35 associated with the app related to the store or facility located near the user. Information Processing Method

An example of the information processing performed by the information processing system 11 will now be described. For example, the information processing is executed by the control unit 41. The control unit 41 executes information processing by reading a program from the memory unit 42. The control unit 41 executes the information processing illustrated in FIG. 10, for example, when receiving a launch request for the first app 23 or a launch request for the second app 24 from the user terminal 12. The control unit 41 may execute information processing not only when the first app 23 is launched or when the second app 24 is launched, but also, for example, at a predetermined date and time.

As shown in FIG. 10, the control unit 41 acquires history data in step S11. For example, the control unit 41 acquires the first history data 44 and the second history data 45 from the memory unit 42. The control unit 41 may acquire the history data from the service server 15 or from a database.

The control unit 41 may acquire the weight data 48 in step S11. The control unit 41 may acquire the advertisement data 49 in step S11. The control unit 41 may acquire the user data 50 in step S11. The control unit 41 may acquire the weight data 48, the advertisement data 49, and the user data 50 from the service server 15 or from a database. The control unit 41 may directly acquire the location information of the user from the user terminal 12.

In step S12, the control unit 41 generates format data based on the history data. For example, upon receiving a launch request from the first app 23, the control unit 41 generates the first format data 46 based on the first history data 44 and the second history data 45. Upon receiving a launch request from the second app 24, the control unit 41 generates the second format data 47 based on the first history data 44 and the second history data 45.

In step S12, the control unit 41 may generate format data based on the history data and the weight data 48. In step S12, the control unit 41 may generate format data based on at least one of the weight data 48, the advertisement data 49, and the user data 50 in addition to the history data.

In step S13, the control unit 41 sends the format data to the user terminal 12. For example, upon receiving a launch request from the first app 23, the control unit 41 sends the first format data 46 to the user terminal 12. Upon receiving a launch request from the second app 24, the control unit 41 sends the second format data 47 to the user terminal 12.

Accordingly, the control unit 41 causes the user terminal 12 to display a group of icons on the display screen in a display format that is based on the format data. As a result, the group of icons is displayed on the display screen in a display format according to the operation history of the user. This improves the usability. After terminating the process of step S13, the control unit 41 ends the information processing.

### Operation and Advantages of Embodiment

The operation and advantages of the above-described embodiment will now be described.

(1) The control unit 41 acquires at least one of the first history data 44 and the second history data 45. The control unit 41 generates the first format data 46 and the second format data 47 based on at least one of the first history data 44 and the second history data 45. The control unit 41 displays a group of icons on the first display screen 33 in a display format that is based on the first format data 46. The control unit 41 displays a group of icons on the second display screen 34 in a display format that is based on the second format data 47. This configuration allows the information processing system 11 to suitably display the icons 35 based on the operation history.

(2) The first format data 46 indicates the order of multiple icons 35 on the first display screen 33. The second format data 47 indicates the order of multiple icons 35 on the second display screen 34. This configuration allows the information processing system 11 to display multiple icons 35 in a suitable order based on the operation history.

(3) The control unit 41 generates the first format data 46 and the second format data 47 based on the sum of the number of operations indicated by the first history data 44 and the number of operations indicated by the second history data 45. This configuration allows the information processing system 11 to suitably display the icons 35 based on the number of operations performed on each of the icons 35.

(4) The control unit 41 generates the first format data 46 and the second format data 47 based on the sum of the value obtained by correcting, with the first weight value, the number of operations indicated by the first history data 44 and the value obtained by correcting, with the second weight value, which is different from the first weight value, the number of operations indicated by the second history data 45. This configuration allows the information processing system 11 to generate the first format data 46 and the second format data 47 in a state in which the first history data 44 is evaluated with greater weight than the second history data 45. This configuration also allows the information processing system 11 to generate the first format data 46 and the second format data 47 in a state in which the second history data 45 is evaluated with greater weight than the first history data 44. Thus, for example, when the first app 23 is operated more frequently than the second app 24, the information processing system 11 suitably displays icons 35 to the user who uses the first app 23 by evaluating the first history data 44 with greater weight than the second history data 45.

(5) The control unit 41 generates the first format data 46 based on the sum of the value obtained by correcting, with the first weight value, the number of operations indicated by the first history data 44 and the value obtained by correcting, with the second weight value, which is smaller than the first weight value, the number of operations indicated by the second history data 45. The control unit 41 generates the second format data 47 based on the sum of the value obtained by correcting, with the third weight value, the number of operations indicated by the first history data 44 and the value obtained by correcting, with the fourth weight value, which is larger than the third weight value, the number of operations indicated by the second history data 45. This configuration allows the information processing system 11 to generate the first format data 46 in a state in which the first history data 44 is evaluated with greater weight than the second history data 45. The information processing system 11 generates the second format data 47 in a state in which the second history data 45 is evaluated with greater weight than the first history data 44. That is, the information processing system 11 displays a group of icons in the first app 23 in a display format that strongly reflects the operation history of the first app 23. The information processing system 11 displays a group of icons in the second app 24 in a display format that strongly reflects the operation history of the second app 24. This allows the information processing system 11 to suitably display the icons 35 in each of the first app 23 and the second app 24.

(6) The control unit 41 generates the first format data 46 and the second format data 47 based on the advertisement data 49, the first history data 44, and the second history data 45. This configuration allows the information processing system 11 to suitably display the icons 35 based on the advertisement data 49 in addition to the operation history.

(7) When the icons 35 displayed on the first display screen 33 are identical to the icons 35 displayed on the second display screen 34, the control unit 41 generates the first format data 46 and the second format data 47 such that the display format of the group of icons on the first display screen 33 matches the display format of the group of icons on the second display screen 34. In this configuration, since the icons 35 are displayed in the same manner on the first display screen 33 and the second display screen 34, the user experiences of the first app 23 and the second app 24 are made consistent.

(8) The control unit 41 generates the first format data 46 and the second format data 47 based on the user data 50, the first history data 44, and the second history data 45. This configuration allows the information processing system 11 to suitably display the icons 35 based on the user data 50 in addition to the operation history.

### Modifications

The above-described embodiment can be modified as follows. The above-described embodiment and the following modifications can be combined with each other as long as there is no technical contradiction.

### First Modification

The user terminal 12 may execute information processing. For example, the user terminal 12 may store history data, or may acquire history data from a server such as the display control server 14 and the service server 15. The user terminal 12 may generate format data based on history data. The user terminal 12 may display a display screen based on format data. The program that causes the computer to execute information processing may be included in the first app 23 and the second app 24.

### Second Modification

The weight data 48 may store only the first weight value and the second weight value. In this case, the third result value may be derived by correcting the first history data 44 with the second weight value. The fourth result value may be derived by correcting the second history data 45 with the first weight value.

### Third Modification

The weight value indicated by the weight data 48 is not limited to a preset fixed value, and may be a variable value. For example, the weight value may vary based on the advertisement data 49, or may vary based on the user data 50. That is, the advertisement data 49 and the user data 50 may be used to correct history data.

The technical ideas understood from the above-described embodiment and the modifications are as follows.

[Clause 1] An information processing system that displays multiple icons respectively associated with multiple services in a first app and a second app, the first app and the second app each providing the services, the information processing system including:
a storage unit configured to store a program; and
a control unit configured to execute a process in accordance with the program, and
the control unit is configured to execute:
   acquiring at least one of first history data and second history data, where the first history data indicates an operation history of the icons in the first app, and the second history data indicates an operation history of the icons in the second app;
   generating first format data and second format data based on at least one of the first history data and the second history data, where the first format data indicates a display format of the icons in the first app, and the second format data indicates a display format of the icons in the second app;
   displaying the icons in the display format that is based on the first format data in the first app; and
   displaying the icons in the display format that is based on the second format data in the second app.

[Clause 2] The information processing system according to clause 1, where
the first format data indicates an order of the icons in the first app, and
the second format data indicates an order of the icons in the second app.

[Clause 3] The information processing system according to clause 1 or 2, where
the first history data includes the number of operations performed on each of the icons in the first app,
the second history data includes the number of operations performed on each of the icons in the second app, and
the control unit is configured to generate the first format data and the second format data based on a sum of the number of operations indicated by the first history data and the number of operations indicated by the second history data.

[Clause 4] The information processing system according to clause 3, where
the control unit is configured to generate the first format data and the second format data based on a sum of a value obtained by correcting, with a first weight value, the number of operations indicated by the first history data and a value obtained by correcting, with a second weight value, the number of operations indicated by the second history data, where the second weight value is different from the first weight value.

[Clause 5] The information processing system according to clause 3, where
the control unit is configured to:
   generate the first format data based on a sum of a value obtained by correcting, with a first weight value, the number of operations indicated by the first history data and a value obtained by correcting, with a second weight value, the number of operations indicated by the second history data, where the second weight value is smaller than the first weight value; and
   generate the second format data based on a sum of a value obtained by correcting, with a third weight value, the number of operations indicated by the first history data and a value obtained by correcting, with a fourth weight value, the number of operations indicated by the second history data, where the fourth weight value is larger than the third weight value.

[Clause 6] The information processing system according to any one of clauses 1 to 5, where
the control unit is configured to generate the first format data and the second format data based on the first history data, the second history data, and advertisement data, where the advertisement data indicates an advertisement fee that is individually set for each of the services.

[Clause 7] The information processing system according to any one of clauses 1 to 6, where
the icons in the first app match the icons in the second app, and
the control unit is configured to generate the first format data and the second format data such that the display format of the icons in the first app matches the display format of the icons in the second app.

[Clause 8] The information processing system according to any one of clauses 1 to 7, where
the control unit is configured to generate the first format data and the second format data based on the first history data, the second history data, and user data that relates to a user.

[Clause 9] An information processing method performed by a computer that displays multiple icons respectively associated with multiple services in a first app and a second app, the first app and the second app each providing the services, the information processing method comprising:
acquiring, by the computer, at least one of first history data and second history data, where the first history data indicates an operation history of the icons in the first app, and the second history data indicates an operation history of the icons in the second app;
generating, by the computer, first format data and second format data based on at least one of the first history data and the second history data, where the first format data indicates a display format of the icons in the first app, and the second format data indicates a display format of the icons in the second app;
displaying, by the computer, the icons in the display format that is based on the first format data in the first app; and
displaying, by the computer, the icons in the display format that is based on the second format data in the second app.

[Clause 10] A program that displays multiple icons respectively associated with multiple services in a first app and a second app, the first app and the second app each providing the services, the program causing a computer to execute:
acquiring at least one of first history data and second history data, where the first history data indicates an operation history of the icons in the first app, and the second history data indicates an operation history of the icons in the second app;
generating first format data and second format data based on at least one of the first history data and the second history data, where the first format data indicates a display format of the icons in the first app, and the second format data indicates a display format of the icons in the second app;
displaying the icons in the display format that is based on the first format data in the first app; and
displaying the icons in the display format that is based on the second format data in the second app.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

1. An information processing system, comprising:
one or more memories configured to store program code; and
one or more processors, wherein
the one or more processors are configured to read the program code and operate as instructed by the program code, the program code comprising:
sending code configured to cause at least one of the one or more processors to send, to a user terminal, display data on a display of the user terminal, wherein the display data is used to display a group of icons including multiple icons, and some of the icons are included in both a first display screen of a first app and a second display screen of a second app;
history acquisition code configured to cause at least one of the one or more processors to acquire at least one of first history data and second history data, wherein the first history data indicates an operation history of a group of icons in the first app, and the second history data indicates an operation history of a group of icons in the second app; and
format code configured to cause at least one of the one or more processors to generate first format data and second format data based on at least one of the first history data and the second history data, wherein the first format data indicates a display format of the group of icons on the first display screen, and the second format data indicates a display format of the group of icons on the second display screen, and
the display data includes:
first display data used to display the group of icons on the first display screen in the display format that is based on the first format data; and
second display data used to display the group of icons on the second display screen in the display format that is based on the second format data.

2. The information processing system according to claim 1, wherein
the first format data indicates an order of the icons on the first display screen, and
the second format data indicates an order of the icons on the second display screen.

3. The information processing system according to claim 1, wherein
the first history data includes the number of operations performed on each of the icons in the first app,
the second history data includes the number of operations performed on each of the icons in the second app, and
the format code is configured to cause at least one of the one or more processors to generate the first format data and the second format data based on a sum of the number of operations indicated by the first history data and the number of operations indicated by the second history data.

4. The information processing system according to claim 1, wherein
the format code is configured to cause at least one of the one or more processors to generate the first format data and the second format data based on a sum of a value obtained by correcting, with a first weight value, the number of operations indicated by the first history data and a value obtained by correcting, with a second weight value, the number of operations indicated by the second history data, wherein the second weight value is different from the first weight value.

5. The information processing system according to claim 1, wherein
the format code is configured to cause at least one of the one or more processors to:
generate the first format data based on a sum of a value obtained by correcting, with a first weight value, the number of operations indicated by the first history data and a value obtained by correcting, with a second weight value, the number of operations indicated by the second history data, wherein the second weight value is smaller than the first weight value; and
generate the second format data based on a sum of a value obtained by correcting, with a third weight value, the number of operations indicated by the first history data and a value obtained by correcting, with a fourth weight value, the number of operations indicated by the second history data, wherein the fourth weight value is larger than the third weight value.

6. The information processing system according to claim 1, wherein
each of the icons is associated with a respective service, and
the format code is configured to cause at least one of the one or more processors to generate the first format data and the second format data based on the first history data, the second history data, and advertisement data, wherein the advertisement data indicates an advertisement fee that is individually set for each of the services.

7. The information processing system according to claim 1, wherein
the icons displayed on the first display screen are identical to the icons displayed on the second display screen, and
the format code is configured to cause at least one of the one or more processors to generate the first format data and the second format data such that the display format of the group of icons on the first display screen matches the display format of the group of icons on the second display screen.

8. The information processing system according to claim 1, wherein
the format code is configured to cause at least one of the one or more processors to generate the first format data and the second format data based on the first history data, the second history data, and user data, wherein the user data relates to a user who uses the user terminal.

9. An information processing method, comprising:
sending, by at least one of one or more processors, to a user terminal, display data on a display of the user terminal, wherein the display data is used to display a group of icons including multiple icons, and some of the icons are included in both a first display screen of a first app and a second display screen of a second app;
acquiring, by at least one of the one or more processors, at least one of first history data and second history data, wherein the first history data indicates an operation history of a group of icons in the first app, and the second history data indicates an operation history of a group of icons in the second app; and
generating, by at least one of the one or more processors, first format data and second format data based on at least one of the first history data and the second history data, wherein the first format data indicates a display format of the group of icons on the first display screen, and the second format data indicates a display format of the group of icons on the second display screen, wherein
the display data includes:
first display data used to display the group of icons on the first display screen in the display format that is based on the first format data; and
second display data used to display the group of icons on the second display screen in the display format that is based on the second format data.

10. A non-transitory computer-readable medium that stores program code, the program code comprising:
sending code configured to cause at least one of one or more processors to send, to a user terminal, display data on a display of the user terminal, wherein the display data is used to display a group of icons including multiple icons, and some of the icons are included in both a first display screen of a first app and a second display screen of a second app;
history acquisition code configured to cause at least one of the one or more processors to acquire at least one of first history data and second history data, wherein the first history data indicates an operation history of a group of icons in the first app, and the second history data indicates an operation history of a group of icons in the second app; and
format code configured to cause at least one of the one or more processors to generate first format data and second format data based on at least one of the first history data and the second history data, wherein the first format data indicates a display format of the group of icons on the first display screen, and the second format data indicates a display format of the group of icons on the second display screen, and
the display data includes:
first display data used to display the group of icons on the first display screen in the display format that is based on the first format data; and
second display data used to display the group of icons on the second display screen in the display format that is based on the second format data.
